(19) United States
(12) Patent Application Publication
(10) Pub. No.: US 2009/0297409 A1
(43) Pub. Date: Dec. 3, 2009

(54) DISCHARGE PLASMA REACTOR

(76) Inventors: Walter R. Buchanan, Overland Park, KS (US); Christopher D. Hruska, Blue Springs, MO (US)

Correspondence Address: HUSCH BLACKWELL SANDERS LLP, 4801 Main Street, Suite 1000, KANSAS CITY, MO, 64112, US

(21) Appl. No.: 12/130,146

(22) Filed: May 30, 2008

(51) Int. Cl. B01J 19/08

(52) U.S. Cl. 422/186.29

(57) ABSTRACT

The present invention is generally directed to a single or dual dielectric barrier discharge reactor for generating flow discharge plasmas at atmospheric pressure or higher pressures. In particular, the present invention relates to a providing stable, energy efficient, glow discharge plasmas having a controlled discharge gap.

### BACKGROUND OF THE INVENTION

This invention relates generally to a single or dual dielectric barrier discharge reactor for generating glow discharge plasmas at low to high pressures including atmospheric pressure or higher pressures. In particular, the present invention relates to a providing stable, energy efficient, glow discharge plasmas having a controlled discharge gap.

The term “plasma” is generally used to describe fully or partially ionized gases containing many interacting free electrons, ionized atoms or molecules and free radicals. Plasma has many useful applications including, but not limited to, lighting, sound generation, molecular disassociation, surface modification of polymers, cleaning, etching and thin film deposition. This state of matter may be produced by the action of either very high temperatures or strong electric fields whether constant direct current (DC) or time varying radio frequency (RF) or microwave electromagnetic fields. High temperature or “hot” plasmas are represented by celestial light bodies, nuclear explosions and electric arcs. Glow discharge plasmas are produced by free electrons which are energized by an imposed direct current (DC) or RF electric fields and then collide with neutral molecules. These neutral molecule collisions transfer energy to the molecules and form a variety of active species including metastables, atomic species, free radicals and ions. The neutral gas becomes partially or fully ionized and is able to conduct currents. These active species are chemically active and/or physically modify the surface of materials and may therefore serve as the basis of new chemical compounds and property modifications of existing compounds. Discharge plasmas can also produce useful amounts of optical radiation and can therefore be used in light. Moreover, glow discharges and inter-dielectric arc discharges further produce a class of plasmas known as current-maintained plasmas since they are maintained by the passage of current therethrough. Such plasmas conduct only because current is passed therethrough and the conductivity falls off quickly if the source of energy to the charge carriers is removed.

Glow discharge plasmas are a type of low power density plasma and can produce useful amounts of ultraviolet radiation and can do so in the presence of active species. However, known glow discharge plasmas have traditionally only been successfully generated in typically low pressure or partial vacuum environments that necessitate batch processing and the use of expensive vacuum systems. Further developments have nevertheless shown that that plasma sources operating at atmospheric pressure have many advantages over sub-atmospheric plasmas. These advantages include no requirement for a vacuum chamber and the potential to achieve higher density plasma. Moreover, these advantages allow more compact process chamber design, higher processing speeds and lower processing costs.

A conventional dielectric barrier discharge (DBD) reactor consists of two electrodes having at least one dielectric barrier, a high voltage power supply, a gas flow system and various diagnostic instruments. In a conventional DBD, a high voltage alternating current (AC) power supply is used to excite a capacitive load to generate a plasma. The plasma generated using conventional DBD reactors is commonly employed for the surface treatment of relatively thin sheet materials. Conventional DBD reactors also include DC pulse-driven DBDs that are operated in the filamentary or inter-dielectric arc mode. However, only when these conventional DBDs were powered by high frequency AC power supplies was a glow discharge mode available. There are other drawbacks in traditional DBD plasma generation, such as the requirement for high frequency (normally in the RF range), expensive alternating current voltage and complex, impedence matching circuitry.

### SUMMARY OF THE INVENTION

This invention relates generally to a single or dual dielectric barrier discharge reactor for generating glow discharge plasmas at atmospheric pressure or higher pressures. In particular, the present invention relates to a providing stable, energy efficient, glow discharge plasmas having a controlled discharge gap.

In use, the inductively-coupled pulsed DC high pressure plasmas generated by the apparatus and method of the present invention may be useful in many different industries and applications. For example, potential lighting applications include, but are not limited to: thin flat panel combination with a suitable Phosphor and gas for white light source for general lighting; thin flat panel combination with a suitable Phosphor and gas for high intensity, low temperature white light source (replace halogen lamps); thin flat panel in combination with a suitable Phosphor and gas for multi-colored light sources for signage; thin panel backlighting for LCD displays; transparent flat panel lighting fixtures (Windows that turn on to provide light); efficient, low temperature and controllable UV light source for the tanning industry; and, in conjunction with a suitable gas or metal vapor for efficient street lighting.

Potential sound transducer applications include high efficiency, wide dynamic response plasma tweeters and, in combination with the proper drive electronics, to create an audible and ultrasound transducer for frequencies from 2-18,000,000 Hz. Surface treatment applications include: anodization of metals (Al, Si, Ti, Cu), etc for passivation or electrical isolation; nitriding of surfaces for passivation or hardening; SiN, TiN, etc; and removal of residual hydrocarbons or adsorbed water vapor for improved adhesion of surface coatings. Chemical processing applications include: the reactor of the present invention in conjunction with suitable process controls and feed gas for creation of monatomic gasses including hydrogen, nitrogen and oxygen; the reactor of the present invention in conjunction with suitable process controls and feed gas for creation or destruction of Ammonia; the reactor of the present invention in conjunction with suitable process controls and feed gas for creation or destruction of Hydrogen Peroxide; efficient safety burn-off protection for combustible gases (plasma pilot light); the reactor of the present invention in conjunction with suitable feed gas for destruction of hazardous effluents from central station coal fired power plants, chemical processing plants, industrial incinerators; the generation of ozone in water or air. Potential germicidal/sanitation applications include: destroying mold, bacteria and viruses on surfaces; destroying mold, bacteria and viruses in gases (Plasma filter); and destroying mold, bacteria or viruses in liquids (Water purification). The dielectric electrodes and inductive coupling of the present invention allow the plasma cell to operate while submerged in water or other suitable liquid.

Semiconductor industry applications include: efficient Ion source for Ion implantation or Ion surface bombardment; low energy ion source for Shallow Ion Implants; high energy ion source in combination with a suitable accelerating field for high energy ion implantation; in conjunction with a suitable gas or metal vapor for efficient high intensity UV source for lithography; efficient Ionized process gas source for chemical vapor deposition, plasma enhanced chemical vapor deposition, atomic layer deposition, plasma etching, or plasma ashing (polymer stripping); source of high energy ions in conjunction with a suitable acceleration field for high rate physical vapor deposition (sputtering) or ion milling.

Automotive applications include: creation or destruction of nitrous oxides (NOx); long life, fast and efficient ignition source (Plasma Spark Plugs); reduction of un-burned hydrocarbons in automotive exhaust (Replace catalytic converter); high intensity head lights—similar to halogen lamps but more efficient and lower temperature for longer life. Other industrial applications include: operation in inter-dielectric arc mode and at high power for welding or cutting sheet metal; operation in inter-dielectric arc mode and at high power for deposition of metal or ceramic coatings; polymer treatment; waste remediation; textiles; replaces deep liquid penetration with surface reactions (reduce flammability); improved pigment fixation (color dyeing). Medicinal. (Biocompatibility) uses include: biomedical; airborne decontamination; and device sterilization.

### BRIEF DESCRIPTION OF THE SEVERAL VIEWS OF THE DRAWING

In the accompanying drawings that form a part of the specification and that are to be read in conjunction therewith and in which like reference numerals are used to indicate like parts in the various views:

FIG. 1 is a schematic representing the dielectric barrier discharge reactor in accordance with one embodiment of the present invention;

FIG. 2 is a schematic representing the primary and secondary LC tanks in accordance with one embodiment of the present invention;

FIG. 3 is a schematic representing tuning methods for the primary and secondary LC(R) tanks in accordance with one embodiment of the present invention;

FIG. 4 is a schematic representing a method of dynamically controlling the pulse DC power supply using feedback from the primary and second LCR tanks in accordance with one embodiment of the present invention;

FIG. 5 is a schematic representing a method of creating and controlling the pulse DC power supply in accordance with one embodiment of the present invention; and

FIG. 6 is a graphical representation demonstrating the relationship of plasma strength versus power from the DC power supply in accordance with one embodiment of the present invention.

### DETAILED DESCRIPTION OF THE INVENTION

A dielectric barrier discharge reactor 10 embodying various features of the invention is shown in the drawings. Reactor 10 may be housed in a chamber (not shown) capable of controlling temperature, pressure, gas, and/or gas flows into and out of the chamber. In certain desirable applications such as lighting, sound generation, and power generation, a sealed chamber may be desirable. However, for molecular separation and recombination applications, an open system with reactor 10 substantially directly in the path of a high pressure gas flow may be more desirable. In the following embodiments of the present invention, reactor 10 is used to initiate glow discharge plasma at atmospheric pressure, but it is within the scope of the present invention to utilize reactor 10 in any desired atmospheric pressure depending upon the desired application thereof.

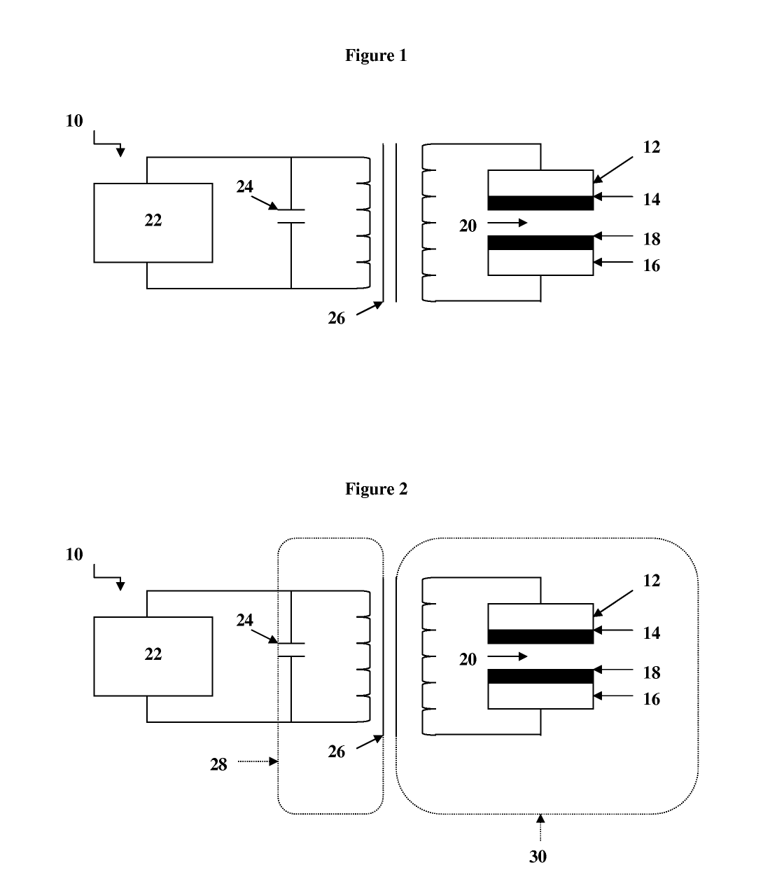

As shown in FIG. 1, one embodiment of reactor 10 generally includes at least one first electrode 12, a first dielectric layer 14 disposed on an inner surface of first electrode 12, at least one second electrode 16 spaced from and, in certain embodiments, at a parallel plane with first electrode 12, a second dielectric layer disposed on an inner surface of second electrode 16, and an electrode gap 20 defined between first and second dielectric layers 14 and 18. First and second electrodes 12 and 16 can have a known and controlled fixed or variable capacitive electrical value and can also have any shape suitable for the intended use of reactor 10 including, but not limited to, conical, cylindrical, parallel, and spherical. In certain embodiments, the inner surfaces of electrodes 12 and 16 are planar. Each of electrodes 12 and 16 may be made of any conductive material suitable for the intended use of the reactor 10. For example, each of electrodes 12 and 16 may be made of copper, silver, stainless steel, steel, monel, aluminum, ruthenium, iridium, titanium, tantalum, oxides of at least one of the foregoing metals, combinations including at least one of the foregoing metals, and the like. In certain embodiments, electrodes 12 and 16 have a nominal thickness and are each fabricated from a single sheet of conductive material. Second electrode 16 can be suspended close to first electrode 12 at a distance effective to allow discharge of plasma within electrode gap 20. Electrodes 12 and 16 may be rigid or flexible depending on the desired application. As shown in FIG. 1, electrodes 12 and 16 are maintained generally flat during operation and generally equally spaced from each other at substantially every point, i.e., electrode 12 is at a parallel plane to electrode 16.

First and second dielectric layers 14 and 18 are generally formed of an insulating material that is disposed on first and second electrodes 12 and 16, respectively. Suitable insulating materials include, but are not limited to, silicon dioxide, silicon nitride, tetraethylorthosilicate, quartz, combinations thereof, and the like. Dielectric layers 14 and 18 may be affixed to electrodes 12 and 16 with an adhesive, coated, deposited, thermally grown, or the like. Suitable coating processes include spin coating, roller coating, dip coating, and the like. Dielectric layers 14 and 18 may also be deposited using such deposition and thermal processes as chemical vapor deposition (CVD), plasma enhanced CVD, rapid thermal processing, and the like. The thickness of each of dielectric layers 14 and 18 is generally chosen to provide a sufficient dielectric breakdown voltage to initiate plasma formation and excitation of a gas, such as nitrogen and/or oxygen, within electrode gap 20 which, in turn, depends on the potential between first electrode 12 and second electrode 16. For example, each of dielectric layers 14 and 18 may have a thickness such that, when a current is applied to first electrode 12 and second electrode 16, multiple electrical discharges begin ionizing the gas within electrode gap 20 into a plasma and producing radicals. Meanwhile, however, those discharges are charging up the dielectric layers 14 and 18 (either negatively or positively depending on the polarity). The thickness of dielectric layers 14 and 18 are therefore based on the applied power and are selected to prevent the formation of the inter-dielectric arc across electrodes 12 and 16. Moreover, it will be appreciated by those skilled in the art that, while the embodiment shown in the figures uses two electrodes and two dielectric layers, it is well within the scope of the present invention for reactor 10 to include single or multiple electrodes with single or multiple dielectric barriers in conjunction with multiple power supplies to create multiple glow discharge plasma sources. The power supplies may be run in parallel or multiplexed to drive the electrodes at fractional harmonics. The reactor 10 of the present invention therefore provides both the necessary power and control suitable for use in both glow and inter-dielectric arc discharge modes. Thus, when in inter-dielectric arc discharge mode wherein electrical arcs are allowed to form across electrodes 12 and 16 and no dielectric layers are present, reactor 10 may conveniently be used in capacitive discharge ignition (CDI) systems in automobiles or the like. In this mode, neither the primary nor the secondary side of the transformer oscillates as discussed in more detail hereinbelow.

Reactor 10 further includes a pulsed direct current (DC) first power supply 22 operably connected to a parallel circuit of an input tuning/matching capacitor 24 and a primary winding of a coupling inductor 26. In certain embodiments, coupling inductor 26 is the secondary winding of a transformer and is configured to transfer power to reactor 10 from power supply 22 to electrodes 12 and 16 for initiating plasma discharge in electrode gap 20. However, it will be appreciated by those skilled in the art that any ratio of primary to secondary turns in the coupling inductor 26 may be used. In one embodiment, 8 turns for the primary and 300 for the secondary may be used. In other embodiments, the ratio of primary to secondary turns is preferably within the range of from about 1/20 to 1/2000 of the desired energy transfer. Using a smaller number on the primary and a larger number on the secondary allows the primary capacitor to be much larger than the second capacitor and still remain tuned.

First power supply 22 may include an independently-controlled output switching component (not shown). Power supply 22 generally provides a pulse at frequencies ranging from less than about 1 kHz to about several MHz. In certain embodiments, the frequency is from less than about 1 kHz to about 20 kHz. Frequency is generally calculated as 1/cycle time which, in turn, is the sum of pulse duration and time between pulses. Therefore, preferred pulse period times range from about 100 nS to about 1 Second and preferred pulse duration ranges from about 40 nS to greater than about 120 μS. Rise time of the pulse may vary from about 5 nS to about 200 nS and the fall time may be within the range of from about 5 nS to greater than about 200 nS. The power necessary to initiate plasma discharge across electrode gap 20 can vary depending on the desired application and efficiency. In certain embodiments, the power is greater than about 0.4 watts to about 100 watts. The voltages applied to electrodes 12 and 16 are in the range of from about 8 volts to about 2000 volts and is only limited by the switching component available. More preferably, the voltages applied are in the range of about 8 to 15 volts.

Another embodiment of the present invention is shown in FIG. 2 wherein reactor 10 further includes a primary LC resonant tank circuit 28 and a secondary LC resonant tank circuit 30. In this embodiment, LCR tank circuit 28 includes first power supply 22 having an independently-controlled output switching component (now shown) operably connected to input tuning/matching capacitor 24 and terminals (now shown) of coupling inductor 26. In use, application of a DC pulse from first power supply 22 causes a resonant tank (not shown) to initiate first resonant oscillation frequency Ω₂ in primary LCR tank circuit 28 thereby resulting in highly efficient power transfer from the DC pulse to LCR tank circuit 28. Coupling inductor 26 then transfers energy from a primary side 32 of coupling inductor 26 to a secondary side 34 thereby forming secondary LCR tank circuit 30 wherein first and second electrodes 12 and 16 function as a capacitor. It will be appreciated by those skilled in the art that the capacitor formed by electrodes 12 and 16 and other capacitors used or suitable for use in the present invention may be in series with or parallel to the DBD and inductor 26. In this embodiment, the energy transfer from primary LCR tank circuit 28 to secondary LCR tank circuit 30 initiates a second resonant oscillation frequency Ω₂ in the secondary LCR tank circuit 30. The frequency and voltage of the Ω₂ and Ω₂ oscillation is a function of the value of the secondary side 34 of coupling inductor 26 and the capacitor formed by electrodes 12 and 16 in conjunction with the known effects of the primary side 32 of coupling inductor 26. These values are may be readily calculated using known means. In certain embodiments of the present invention, Ω₂ can be in the range of from about 50 kHz to about 10 MHz whereas Ω₂ can be in the range of from about 200 kHz to about 200 MHz. In certain embodiments, Ω₂ associated with the primary side is normally a lower frequency than the secondary.

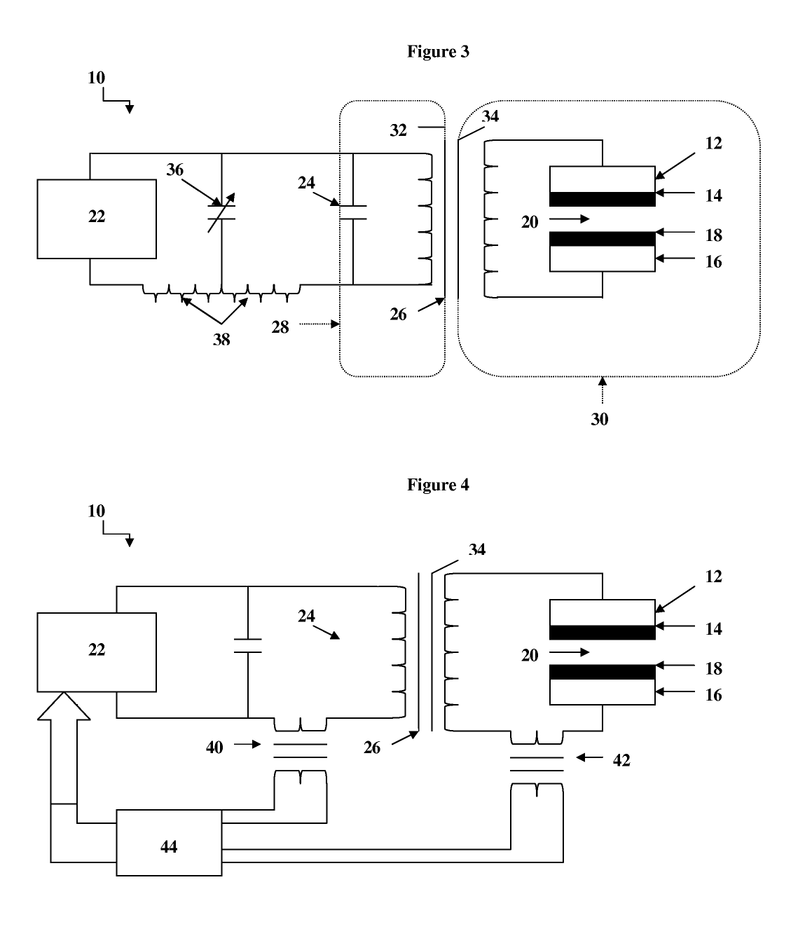

Moreover, it will be appreciated by those skilled in the art that, depending upon the requirements of a particular operation condition or application, the desired energy transfer rate may be altered or enhanced by selecting the electrical characteristics of the different components of reactor 10 and/or by selectively altering the frequency, peak voltage and pulse duration of power supply 22. Further, as needed for particular applications, additional components may be added to reactor 10 without departing from the scope of the present invention. For example, at least one series resistor and at least one series or parallel inductor may be added to reactor 10 to enhance control and match impedance. Thus, as shown in FIG. 3, reactor 10 may further include at least one additional tuning inductor and/or capacitor 36 as well as at least one tuning inductor 38 thereby allowing primary LCR tank circuit 28 to be tuned in order to enhance the transfer of energy from primary circuit 28 to secondary circuit 30 and to control the resonant oscillation frequencies Ω₁ and Ω₂ of the same. This allows for better control of plasma glow discharge within electrode gap 20. However, any suitable means for tuning the primary and secondary LCR tank circuits 28 and 30 may be used. It will also be appreciated by those skilled in the art that, instead of using the inductor in secondary LCR tank circuit 30 as a part of the coupling transformer, it is within the scope of the present invention to power secondary LCR tank circuit 30 directly by firing a high voltage pulse at secondary circuit 30 such as by directly powering circuit 30 using a DC pulse in resonant mode.

Turning now to FIG. 4, a method of dynamically controlling power supply 22 using a first amplitude or inductive sensor 40 and a second amplitude or inductive sensor 42 is shown. Sensors 40 and 42 can be resistive or capacitive and may be disposed anywhere within primary and secondary circuits 28 and 30 including as an integral part of coupling inductor 26 depending upon the particular need or application. In this method, inductive sensors 40 and 42 are used to provide feedback from circuits 28 and 30 to a computer controller 44. The feedback is used to monitor the amplitude and phase of the tank circuit voltage as well as the status of the plasma thereby providing sufficient information for controller 44 to correct and adjust the phase and timing of the DC pulse from power supply 22 into primary LCR tank circuit 28.

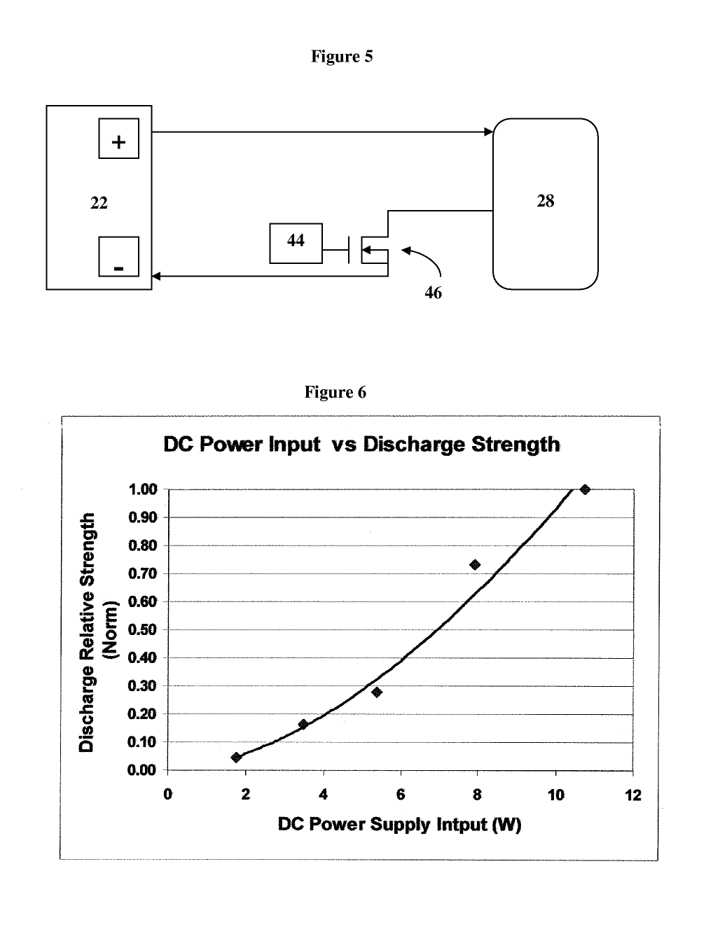

FIG. 5 demonstrates one method to form the DC pulse from power supply 22. However, it will be appreciated by those skilled in the art that any suitable method now known or hereafter developed may be used without departing from the scope of the present invention. In this embodiment, the positive terminal (not shown) of a simple DC power supply 22 is operably attached to a first terminal (not shown) capacitor 24 and coupling inductor 26. The drain of a N-channel metal-oxide-semiconductor field-effect transistor (nMOSFET) 46 is operably connected to a second terminal (not shown) of capacitor 24 and coupling inductor 26. nMOSFET 46 may be switched on and off using a simple circuit (not shown) controlled by controller 44 wherein the circuit is adjustable in both frequency and pulse duration thereby allowing the voltage to the primary LCR tank circuit 28 to be adjusted by varying the voltage in power supply 22. Moreover, the pulse frequency and duration may be adjusted using a pulse timing circuit (not shown).

Accordingly, the apparatus and method of the present invention provide an energy efficient, low cost and stable glow discharge plasma by using a single voltage DC voltage source, low cost switching electronics, and a novel drive circuit and coupling method. FIG. 6 demonstrates the relationship between the power supplied by power supply 22 to the relative plasma intensity in air at atmospheric pressure. As shown therein, the apparatus of the present invention is capable of generating stable glow discharge plasma in response to relatively low power supply input without the need for the high RF frequencies, alternating current voltage and expensive control circuitry common to conventional DBD plasma generation.

From the foregoing, it may be seen that the inventive plasma discharge reactor apparatus and method of using the same is particularly well suited for the proposed usages thereof. Furthermore, since certain changes may be made in the above invention without departing from the scope hereof, it is intended that all matter contained in the above description or shown in the accompanying drawing be interpreted as illustrative and not in a limiting sense. It is also to be understood that the following claims are to cover certain generic and specific features described herein.

We claim:

1. A reactor for generating a plasma discharge comprising:
at least one first electrode having a dielectric barrier layer disposed thereon;
at least one second electrode having a dielectric barrier layer disposed thereon;
a pulsed DC power source inductively coupled to an RF resonant tank; and
a coupling inductor.

2. The reactor of claim 1, wherein said plasma discharge is contained in a manner selected from the group consisting of a closed chamber, open atmosphere, in a pressurized gas, and a gas flow.

3. The reactor of claim 1, wherein said first and second electrodes form a capacitor with said dielectric barrier layers.

4. The reactor of claim 1 further comprising an electrode gap disposed between said dielectric barrier layers configured for containing a gas or liquid therein.

5. The reactor of claim 4 further comprising at least one inductor and at least one resistor connected to said capacitor to form a primary LCR tank circuit.

6. The reactor of claim 5 wherein said inductor, said capacitor, and said resistor are disposed in parallel or series with said reactor for controlling oscillation frequency and energy transfer from said power source.

7. The reactor of claim 6 wherein one of said inductors is a secondary winding of a transformer and configured to transfer power to said primary LCR tank circuit and said electrodes.

8. The reactor of claim 7 wherein one of said inductors is a primary winding of a transformer and configured to complement an oscillation frequency of a secondary LCR tank circuit.

9. The reactor of claim 8 wherein said power source provides a direct current pulse to power said primary LCR tank circuit and induce high frequency oscillations in said secondary LCR tank circuit through said transformer thereby powering said secondary LCR tank circuit.

10. The reactor of claim 9 wherein the frequency, pulse duration, pulse rise and pulse fall time is adjustable between free-running operation and dynamically variable from pulse to pulse.

11. The reactor of claim 10 wherein said oscillation includes an amplitude and phase configured to be sensed dynamically.

12. The reactor of claim 11 further comprising a computer controller for maintaining said phase and said amplitude in a desired phase relationship.
